(19) United States
(12) Patent Application Publication
(10) Pub. No.: US 2022/0357983 A1
(43) Pub. Date: Nov. 10, 2022

(54) METHODS AND APPARATUS FOR WAVE SLOT RETIREMENT PROCEDURES

(71) Applicant: QUALCOMM Incorporated, San Diego, CA (US)

(72) Inventors: Yun DU, San Diego, CA (US); Andrew Evan GRUBER, Arlington, MA (US); Zilin YING, San Diego, CA (US); Gang ZHONG, San Diego, CA (US); Baoguang YANG, Fremont, CA (US); Yang YU, San Diego, CA (US); Yang XIA, San Diego, CA (US); Ravindra KUMAR, San Diego, CA (US); Chun YU, Rancho Santa Fe, CA (US); Eric DEMERS, San Diego, CA (US)

(21) Appl. No.: 17/315,205

(22) Filed: May 7, 2021

(51) Int. Cl. G06F 9/48; G06F 12/0875; G06T 1/20

(52) U.S. Cl. CPC G06F 9/4881; G06F 12/0875; G06T 1/20; G06F 2212/302

(57) ABSTRACT

The present disclosure relates to methods and devices for graphics processing including an apparatus, e.g., a GPU. The apparatus may receive a plurality of workloads based on a workload order, each of the plurality of workloads being received in the workload order including at least a first workload and a second workload. The apparatus may also allocate one or more workloads of the plurality of workloads to one or more wave slots. Additionally, the apparatus may execute the one or more allocated workloads at the one or more wave slots, such that at least the first workload is executed at the first wave slot and the second workload is executed at the second wave slot. The apparatus may also allocate at least one other workload of the plurality of workloads to at least one previously-allocated wave slot of the one or more wave slots.

### TECHNICAL FIELD

The present disclosure relates generally to processing systems and, more particularly, to one or more techniques for graphics processing.

### INTRODUCTION

Computing devices often perform graphics and/or display processing (e.g., utilizing a graphics processing unit (GPU), a central processing unit (CPU), a display processor, etc.) to render and display visual content. Such computing devices may include, for example, computer workstations, mobile phones such as smartphones, embedded systems, personal computers, tablet computers, and video game consoles. GPUs are configured to execute a graphics processing pipeline that includes one or more processing stages, which operate together to execute graphics processing commands and output a frame. A central processing unit (CPU) may control the operation of the GPU by issuing one or more graphics processing commands to the GPU. Modern day CPUs are typically capable of executing multiple applications concurrently, each of which may need to utilize the GPU during execution. A display processor is configured to convert digital information received from a CPU to analog values and may issue commands to a display panel for displaying the visual content. A device that provides content for visual presentation on a display may utilize a GPU and/or a display processor.

A GPU of a device may be configured to perform the processes in a graphics processing pipeline. Further, a display processor or display processing unit (DPU) may be configured to perform the processes of display processing. However, with the advent of wireless communication and smaller, handheld devices, there has developed an increased need for improved graphics or display processing.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided. The apparatus may be a graphics processing unit (GPU) or any apparatus that can perform graphics processing. The apparatus may receive a plurality of workloads based on a workload order, each of the plurality of workloads being received in the workload order including at least a first workload and a second workload. The apparatus may also store, upon receiving the plurality of workloads, each of the plurality of workloads in a sequence queue, where each of the plurality of workloads are stored in the sequence queue based on the workload order. Additionally, the apparatus may allocate, based on the workload order, one or more workloads of the plurality of workloads to one or more wave slots of a plurality of wave slots, such that at least the first workload is allocated to a first wave slot of the plurality of wave slots and the second workload is allocated to a second wave slot of the plurality of wave slots. The apparatus may also execute the one or more allocated workloads at the one or more wave slots, such that at least the first workload is executed at the first wave slot and the second workload is executed at the second wave slot. The apparatus may also determine whether at least one of the one or more allocated workloads is finished executing when at least one of the one or more allocated workloads is still executing. Moreover, the apparatus may allocate, upon finishing executing at least one of the one or more allocated workloads, at least one other workload of the plurality of workloads to at least one previously-allocated wave slot of the one or more wave slots, the at least one previously-allocated wave slot having executed at least one of the one or more allocated workloads. The apparatus may also execute, upon allocating the at least one other workload to the at least one previously-allocated wave slot, the at least one other workload at the at least one previously-allocated wave slot. The apparatus may also transmit or copy each of the one or more executed workloads to a buffer or an eviction buffer; and store each of the one or more executed workloads at the buffer or the eviction buffer.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram that illustrates an example content generation system in accordance with one or more techniques of this disclosure.

FIG. 2 illustrates an example GPU in accordance with one or more techniques of this disclosure.

FIG. 3 illustrates an example image or surface in accordance with one or more techniques of this disclosure.

FIG. 4 is a diagram illustrating an example GPU in accordance with one or more techniques of this disclosure.

FIG. 5 is a diagram illustrating an example sequence queue and example wave slots in accordance with one or more techniques of this disclosure.

FIG. 6 is a diagram illustrating an example wave slot allocation in accordance with one or more techniques of this disclosure.

FIG. 7 is a diagram illustrating an example sequence queue and example wave slots in accordance with one or more techniques of this disclosure.

FIG. 8 is a communication flow diagram illustrating example communications between a GPU pipeline, a GPU component, and a memory/buffer in accordance with one or more techniques of this disclosure.

FIG. 9 is a flowchart of an example method of graphics processing in accordance with one or more techniques of this disclosure.

### DETAILED DESCRIPTION

In aspects of graphics processing, there are applications that may depend on memory fetch data test results. For example, for high level shaders in graphics processing, a shader may continue issuing texture sample instructions until the results meet a threshold. This may cause a high amount of complex instructions/paths, and most instructions/paths may have memory fetched inside this loop, which causes a pixel/wave execution cycle to vary drastically. This may also result in wave execution completion in a non-linear or non-sequential order, i.e., wave slots finish executing workloads out-of-order compared to the workload order. For wave slots executing certain instructions, e.g., a pixel warp, that complete execution early, the wave slot may wait until wave slots with a higher priority order complete execution and dispatch the result. These wave slots may then retire and are ready for a new workload. As such, there may be a large amount of time wasted for wave slots that finish executing an instruction/workload before wave slots with a higher priority. Aspects of the present disclosure may allocate workloads to wave slots based on the availability of wave slots. As such, aspects of the present disclosure may help to reduce the amount of time wave slots spend waiting for other wave slots to execute workloads/instructions. Further, by allocating workloads to wave slots based on wave slot availability, aspects of the present disclosure may more efficiently utilize wave slots to handle incoming workloads. For example, aspects of the present disclosure may allocate workloads to wave slots based on when certain wave slots complete execution, rather than allocating workloads to wave slots in a linear or sequential order. Therefore, aspects of the present disclosure may allocate and execute workloads in a non-linear or non-sequential order.

Various aspects of systems, apparatuses, computer program products, and methods are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of this disclosure to those skilled in the art. Based on the teachings herein one skilled in the art should appreciate that the scope of this disclosure is intended to cover any aspect of the systems, apparatuses, computer program products, and methods disclosed herein, whether implemented independently of, or combined with, other aspects of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. Any aspect disclosed herein may be embodied by one or more elements of a claim.

Although various aspects are described herein, many variations and permutations of these aspects fall within the scope of this disclosure. Although some potential benefits and advantages of aspects of this disclosure are mentioned, the scope of this disclosure is not intended to be limited to particular benefits, uses, or objectives. Rather, aspects of this disclosure are intended to be broadly applicable to different wireless technologies, system configurations, networks, and transmission protocols, some of which are illustrated by way of example in the figures and in the following description. The detailed description and drawings are merely illustrative of this disclosure rather than limiting, the scope of this disclosure being defined by the appended claims and equivalents thereof.

Several aspects are presented with reference to various apparatus and methods. These apparatus and methods are described in the following detailed description and illustrated in the accompanying drawings by various blocks, components, circuits, processes, algorithms, and the like (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors (which may also be referred to as processing units). Examples of processors include microprocessors, microcontrollers, graphics processing units (GPUs), general purpose GPUs (GPGPUs), central processing units (CPUs), application processors, digital signal processors (DSPs), reduced instruction set computing (RISC) processors, systems-on-chip (SOC), baseband processors, application specific integrated circuits (ASICs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software can be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise. The term application may refer to software. As described herein, one or more techniques may refer to an application, i.e., software, being configured to perform one or more functions. In such examples, the application may be stored on a memory, e.g., on-chip memory of a processor, system memory, or any other memory. Hardware described herein, such as a processor may be configured to execute the application. For example, the application may be described as including code that, when executed by the hardware, causes the hardware to perform one or more techniques described herein. As an example, the hardware may access the code from a memory and execute the code accessed from the memory to perform one or more techniques described herein. In some examples, components are identified in this disclosure. In such examples, the components may be hardware, software, or a combination thereof. The components may be separate components or sub-components of a single component.

Accordingly, in one or more examples described herein, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

In general, this disclosure describes techniques for having a graphics processing pipeline in a single device or multiple devices, improving the rendering of graphical content, and/or reducing the load of a processing unit, i.e., any processing unit configured to perform one or more techniques described herein, such as a GPU. For example, this disclosure describes techniques for graphics processing in any device that utilizes graphics processing. Other example benefits are described throughout this disclosure.

As used herein, instances of the term “content” may refer to “graphical content,” “image,” and vice versa. This is true regardless of whether the terms are being used as an adjective, noun, or other parts of speech. In some examples, as used herein, the term “graphical content” may refer to a content produced by one or more processes of a graphics processing pipeline. In some examples, as used herein, the term “graphical content” may refer to a content produced by a processing unit configured to perform graphics processing. In some examples, as used herein, the term “graphical content” may refer to a content produced by a graphics processing unit.

In some examples, as used herein, the term “display content” may refer to content generated by a processing unit configured to perform displaying processing. In some examples, as used herein, the term “display content” may refer to content generated by a display processing unit. Graphical content may be processed to become display content. For example, a graphics processing unit may output graphical content, such as a frame, to a buffer (which may be referred to as a framebuffer). A display processing unit may read the graphical content, such as one or more frames from the buffer, and perform one or more display processing techniques thereon to generate display content. For example, a display processing unit may be configured to perform composition on one or more rendered layers to generate a frame. As another example, a display processing unit may be configured to compose, blend, or otherwise combine two or more layers together into a single frame. A display processing unit may be configured to perform scaling, e.g., upscaling or downscaling, on a frame. In some examples, a frame may refer to a layer. In other examples, a frame may refer to two or more layers that have already been blended together to form the frame, i.e., the frame includes two or more layers, and the frame that includes two or more layers may subsequently be blended.

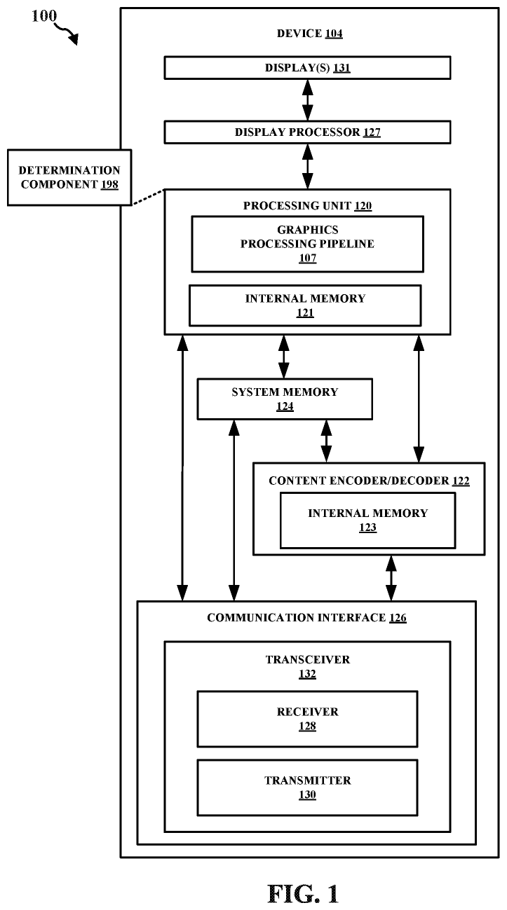

FIG. 1 is a block diagram that illustrates an example content generation system 100 configured to implement one or more techniques of this disclosure. The content generation system 100 includes a device 104. The device 104 may include one or more components or circuits for performing various functions described herein. In some examples, one or more components of the device 104 may be components of an SOC. The device 104 may include one or more components configured to perform one or more techniques of this disclosure. In the example shown, the device 104 may include a processing unit 120, a content encoder/decoder 122, and a system memory 124. In some aspects, the device 104 can include a number of optional components, e.g., a communication interface 126, a transceiver 132, a receiver 128, a transmitter 130, a display processor 127, and one or more displays 131. Reference to the display 131 may refer to the one or more displays 131. For example, the display 131 may include a single display or multiple displays. The display 131 may include a first display and a second display. The first display may be a left-eye display and the second display may be a right-eye display. In some examples, the first and second display may receive different frames for presentment thereon. In other examples, the first and second display may receive the same frames for presentment thereon. In further examples, the results of the graphics processing may not be displayed on the device, e.g., the first and second display may not receive any frames for presentment thereon. Instead, the frames or graphics processing results may be transferred to another device. In some aspects, this can be referred to as split-rendering.

The processing unit 120 may include an internal memory 121. The processing unit 120 may be configured to perform graphics processing, such as in a graphics processing pipeline 107. The content encoder/decoder 122 may include an internal memory 123. In some examples, the device 104 may include a display processor, such as the display processor 127, to perform one or more display processing techniques on one or more frames generated by the processing unit 120 before presentment by the one or more displays 131. The display processor 127 may be configured to perform display processing. For example, the display processor 127 may be configured to perform one or more display processing techniques on one or more frames generated by the processing unit 120. The one or more displays 131 may be configured to display or otherwise present frames processed by the display processor 127. In some examples, the one or more displays 131 may include one or more of: a liquid crystal display (LCD), a plasma display, an organic light emitting diode (OLED) display, a projection display device, an augmented reality display device, a virtual reality display device, a head-mounted display, or any other type of display device.

Memory external to the processing unit 120 and the content encoder/decoder 122, such as system memory 124, may be accessible to the processing unit 120 and the content encoder/decoder 122. For example, the processing unit 120 and the content encoder/decoder 122 may be configured to read from and/or write to external memory, such as the system memory 124. The processing unit 120 and the content encoder/decoder 122 may be communicatively coupled to the system memory 124 over a bus. In some examples, the processing unit 120 and the content encoder/decoder 122 may be communicatively coupled to each other over the bus or a different connection.

The content encoder/decoder 122 may be configured to receive graphical content from any source, such as the system memory 124 and/or the communication interface 126. The system memory 124 may be configured to store received encoded or decoded graphical content. The content encoder/decoder 122 may be configured to receive encoded or decoded graphical content, e.g., from the system memory 124 and/or the communication interface 126, in the form of encoded pixel data. The content encoder/decoder 122 may be configured to encode or decode any graphical content.

The internal memory 121 or the system memory 124 may include one or more volatile or non-volatile memories or storage devices. In some examples, internal memory 121 or the system memory 124 may include RAM, SRAM, DRAM, erasable programmable ROM (EPROM), electrically erasable programmable ROM (EEPROM), flash memory, a magnetic data media or an optical storage media, or any other type of memory.

The internal memory 121 or the system memory 124 may be a non-transitory storage medium according to some examples. The term “non-transitory” may indicate that the storage medium is not embodied in a carrier wave or a propagated signal. However, the term “non-transitory” should not be interpreted to mean that internal memory 121 or the system memory 124 is non-movable or that its contents are static. As one example, the system memory 124 may be removed from the device 104 and moved to another device. As another example, the system memory 124 may not be removable from the device 104.

The processing unit 120 may be a central processing unit (CPU), a graphics processing unit (GPU), a general purpose GPU (GPGPU), or any other processing unit that may be configured to perform graphics processing. In some examples, the processing unit 120 may be integrated into a motherboard of the device 104. In some examples, the processing unit 120 may be present on a graphics card that is installed in a port in a motherboard of the device 104, or may be otherwise incorporated within a peripheral device configured to interoperate with the device 104. The processing unit 120 may include one or more processors, such as one or more microprocessors, GPUs, application specific integrated circuits (ASICs), field programmable gate arrays (FPGAs), arithmetic logic units (ALUs), digital signal processors (DSPs), discrete logic, software, hardware, firmware, other equivalent integrated or discrete logic circuitry, or any combinations thereof. If the techniques are implemented partially in software, the processing unit 120 may store instructions for the software in a suitable, non-transitory computer-readable storage medium, e.g., internal memory 121, and may execute the instructions in hardware using one or more processors to perform the techniques of this disclosure. Any of the foregoing, including hardware, software, a combination of hardware and software, etc., may be considered to be one or more processors.

The content encoder/decoder 122 may be any processing unit configured to perform content decoding. In some examples, the content encoder/decoder 122 may be integrated into a motherboard of the device 104. The content encoder/decoder 122 may include one or more processors, such as one or more microprocessors, application specific integrated circuits (ASICs), field programmable gate arrays (FPGAs), arithmetic logic units (ALUs), digital signal processors (DSPs), video processors, discrete logic, software, hardware, firmware, other equivalent integrated or discrete logic circuitry, or any combinations thereof. If the techniques are implemented partially in software, the content encoder/decoder 122 may store instructions for the software in a suitable, non-transitory computer-readable storage medium, e.g., internal memory 123, and may execute the instructions in hardware using one or more processors to perform the techniques of this disclosure. Any of the foregoing, including hardware, software, a combination of hardware and software, etc., may be considered to be one or more processors.

In some aspects, the content generation system 100 can include an optional communication interface 126. The communication interface 126 may include a receiver 128 and a transmitter 130. The receiver 128 may be configured to perform any receiving function described herein with respect to the device 104. Additionally, the receiver 128 may be configured to receive information, e.g., eye or head position information, rendering commands, or location information, from another device. The transmitter 130 may be configured to perform any transmitting function described herein with respect to the device 104. For example, the transmitter 130 may be configured to transmit information to another device, which may include a request for content. The receiver 128 and the transmitter 130 may be combined into a transceiver 132. In such examples, the transceiver 132 may be configured to perform any receiving function and/or transmitting function described herein with respect to the device 104.

Referring again to FIG. 1, in certain aspects, the processing unit 120 may include a determination component 198 configured to receive a plurality of workloads based on a workload order, each of the plurality of workloads being received in the workload order including at least a first workload and a second workload. The determination component 198 may also be configured to store, upon receiving the plurality of workloads, each of the plurality of workloads in a sequence queue, where each of the plurality of workloads are stored in the sequence queue based on the workload order.

The determination component 198 may also be configured to allocate, based on the workload order, one or more workloads of the plurality of workloads to one or more wave slots of a plurality of wave slots, such that at least the first workload is allocated to a first wave slot of the plurality of wave slots and the second workload is allocated to a second wave slot of the plurality of wave slots. The determination component 198 may also be configured to execute the one or more allocated workloads at the one or more wave slots, such that at least the first workload is executed at the first wave slot and the second workload is executed at the second wave slot. The determination component 198 may also be configured to determine whether at least one of the one or more allocated workloads is finished executing when at least one of the one or more allocated workloads is still executing. The determination component 198 may also be configured to allocate, upon finishing executing at least one of the one or more allocated workloads, at least one other workload of the plurality of workloads to at least one previously-allocated wave slot of the one or more wave slots, the at least one previously-allocated wave slot having executed at least one of the one or more allocated workloads. The determination component 198 may also be configured to execute, upon allocating the at least one other workload to the at least one previously-allocated wave slot, the at least one other workload at the at least one previously-allocated wave slot. The determination component 198 may also be configured to transmit or copy each of the one or more executed workloads to a buffer or an eviction buffer; and store each of the one or more executed workloads at the buffer or the eviction buffer. Although the following description may be focused on graphics processing, the concepts described herein may be applicable to other similar processing techniques.

As described herein, a device, such as the device 104, may refer to any device, apparatus, or system configured to perform one or more techniques described herein. For example, a device may be a server, a base station, user equipment, a client device, a station, an access point, a computer, e.g., a personal computer, a desktop computer, a laptop computer, a tablet computer, a computer workstation, or a mainframe computer, an end product, an apparatus, a phone, a smart phone, a server, a video game platform or console, a handheld device, e.g., a portable video game device or a personal digital assistant (PDA), a wearable computing device, e.g., a smart watch, an augmented reality device, or a virtual reality device, a non-wearable device, a display or display device, a television, a television set-top box, an intermediate network device, a digital media player, a video streaming device, a content streaming device, an in-car computer, any mobile device, any device configured to generate graphical content, or any device configured to perform one or more techniques described herein. Processes herein may be described as performed by a particular component (e.g., a GPU), but, in further embodiments, can be performed using other components (e.g., a CPU), consistent with disclosed embodiments.

GPUs can process multiple types of data or data packets in a GPU pipeline. For instance, in some aspects, a GPU can process two types of data or data packets, e.g., context register packets and draw call data. A context register packet can be a set of global state information, e.g., information regarding a global register, shading program, or constant data, which can regulate how a graphics context will be processed. For example, context register packets can include information regarding a color format. In some aspects of context register packets, there can be a bit that indicates which workload belongs to a context register. Also, there can be multiple functions or programming running at the same time and/or in parallel. For example, functions or programming can describe a certain operation, e.g., the color mode or color format. Accordingly, a context register can define multiple states of a GPU.

Context states can be utilized to determine how an individual processing unit functions, e.g., a vertex fetcher (VFD), a vertex shader (VS), a shader processor, or a geometry processor, and/or in what mode the processing unit functions. In order to do so, GPUs can use context registers and programming data. In some aspects, a GPU can generate a workload, e.g., a vertex or pixel workload, in the pipeline based on the context register definition of a mode or state. Certain processing units, e.g., a VFD, can use these states to determine certain functions, e.g., how a vertex is assembled. As these modes or states can change, GPUs may need to change the corresponding context. Additionally, the workload that corresponds to the mode or state may follow the changing mode or state.

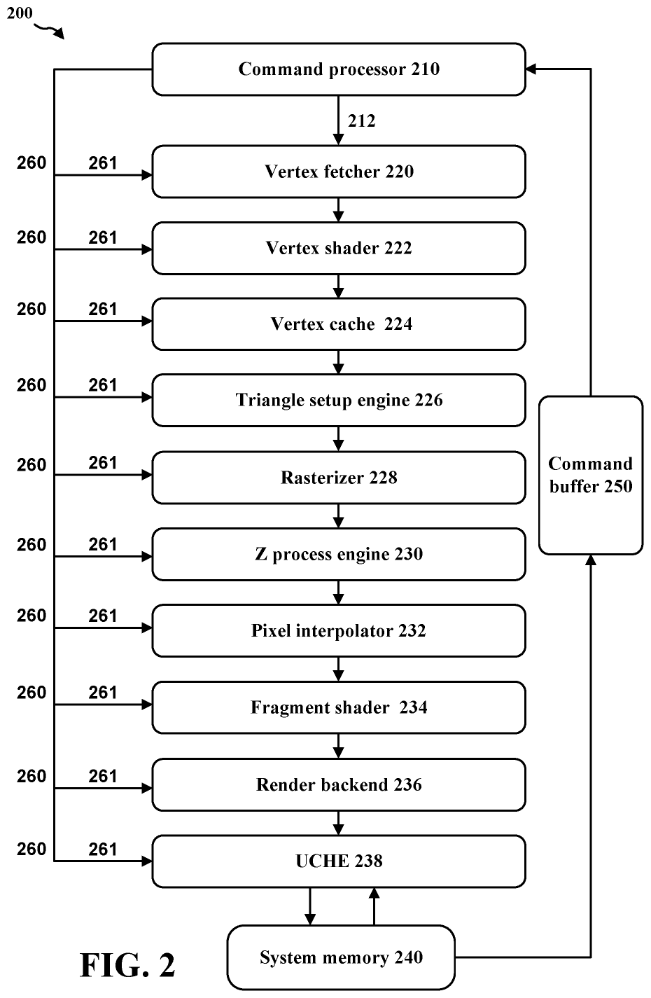

FIG. 2 illustrates an example GPU 200 in accordance with one or more techniques of this disclosure. As shown in FIG. 2, GPU 200 includes command processor (CP) 210, draw call packets 212, VFD 220, VS 222, vertex cache (VPC) 224, triangle setup engine (TSE) 226, rasterizer (RAS) 228, Z process engine (ZPE) 230, pixel interpolator (PI) 232, fragment shader (FS) 234, render backend (RB) 236, level 2 (L2) cache (UCHE) 238, and system memory 240. Although FIG. 2 displays that GPU 200 includes processing units 220-238, GPU 200 can include a number of additional processing units. Additionally, processing units 220-238 are merely an example and any combination or order of processing units can be used by GPUs according to the present disclosure. GPU 200 also includes command buffer 250, context register packets 260, and context states 261.

As shown in FIG. 2, a GPU can utilize a CP, e.g., CP 210, or hardware accelerator to parse a command buffer into context register packets, e.g., context register packets 260, and/or draw call data packets, e.g., draw call packets 212. The CP 210 can then send the context register packets 260 or draw call data packets 212 through separate paths to the processing units or blocks in the GPU. Further, the command buffer 250 can alternate different states of context registers and draw calls. For example, a command buffer can be structured in the following manner: context register of context N, draw call(s) of context N, context register of context N+1, and draw call(s) of context N+1.

GPUs can render images in a variety of different ways. In some instances, GPUs can render an image using rendering and/or tiled rendering. In tiled rendering GPUs, an image can be divided or separated into different sections or tiles. After the division of the image, each section or tile can be rendered separately. Tiled rendering GPUs can divide computer graphics images into a grid format, such that each portion of the grid, i.e., a tile, is separately rendered. In some aspects, during a binning pass, an image can be divided into different bins or tiles. In some aspects, during the binning pass, a visibility stream can be constructed where visible primitives or draw calls can be identified. In contrast to tiled rendering, direct rendering does not divide the frame into smaller bins or tiles. Rather, in direct rendering, the entire frame is rendered at a single time. Additionally, some types of GPUs can allow for both tiled rendering and direct rendering.

In some aspects, GPUs can apply the drawing or rendering process to different bins or tiles. For instance, a GPU can render to one bin, and perform all the draws for the primitives or pixels in the bin. During the process of rendering to a bin, the render targets can be located in the GMEM. In some instances, after rendering to one bin, the content of the render targets can be moved to a system memory and the GMEM can be freed for rendering the next bin. Additionally, a GPU can render to another bin, and perform the draws for the primitives or pixels in that bin. Therefore, in some aspects, there might be a small number of bins, e.g., four bins, that cover all of the draws in one surface. Further, GPUs can cycle through all of the draws in one bin, but perform the draws for the draw calls that are visible, i.e., draw calls that include visible geometry. In some aspects, a visibility stream can be generated, e.g., in a binning pass, to determine the visibility information of each primitive in an image or scene. For instance, this visibility stream can identify whether a certain primitive is visible or not. In some aspects, this information can be used to remove primitives that are not visible, e.g., in the rendering pass. Also, at least some of the primitives that are identified as visible can be rendered in the rendering pass.

In some aspects of tiled rendering, there can be multiple processing phases or passes. For instance, the rendering can be performed in two passes, e.g., a visibility or bin-visibility pass and a rendering or bin-rendering pass. During a visibility pass, a GPU can input a rendering workload, record the positions of the primitives or triangles, and then determine which primitives or triangles fall into which bin or area. In some aspects of a visibility pass, GPUs can also identify or mark the visibility of each primitive or triangle in a visibility stream. During a rendering pass, a GPU can input the visibility stream and process one bin or area at a time. In some aspects, the visibility stream can be analyzed to determine which primitives, or vertices of primitives, are visible or not visible. As such, the primitives, or vertices of primitives, that are visible may be processed. By doing so, GPUs can reduce the unnecessary workload of processing or rendering primitives or triangles that are not visible.

In some aspects, during a visibility pass, certain types of primitive geometry, e.g., position-only geometry, may be processed. Additionally, depending on the position or location of the primitives or triangles, the primitives may be sorted into different bins or areas. In some instances, sorting primitives or triangles into different bins may be performed by determining visibility information for these primitives or triangles. For example, GPUs may determine or write visibility information of each primitive in each bin or area, e.g., in a system memory. This visibility information can be used to determine or generate a visibility stream. In a rendering pass, the primitives in each bin can be rendered separately. In these instances, the visibility stream can be fetched from memory used to drop primitives which are not visible for that bin.

Some aspects of GPUs or GPU architectures can provide a number of different options for rendering, e.g., software rendering and hardware rendering. In software rendering, a driver or CPU can replicate an entire frame geometry by processing each view one time. Additionally, some different states may be changed depending on the view. As such, in software rendering, the software can replicate the entire workload by changing some states that may be utilized to render for each viewpoint in an image. In certain aspects, as GPUs may be submitting the same workload multiple times for each viewpoint in an image, there may be an increased amount of overhead. In hardware rendering, the hardware or GPU may be responsible for replicating or processing the geometry for each viewpoint in an image. Accordingly, the hardware can manage the replication or processing of the primitives or triangles for each viewpoint in an image.

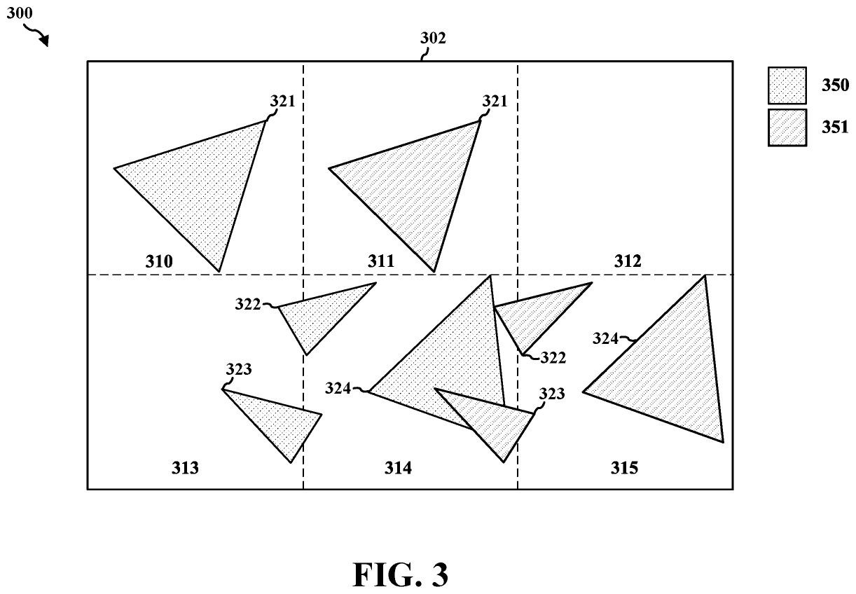

FIG. 3 illustrates image or surface 300, including multiple primitives divided into multiple bins. As shown in FIG. 3, image or surface 300 includes area 302, which includes primitives 321, 322, 323, and 324. The primitives 321, 322, 323, and 324 are divided or placed into different bins, e.g., bins 310, 311, 312, 313, 314, and 315. FIG. 3 illustrates an example of tiled rendering using multiple viewpoints for the primitives 321-324. For instance, primitives 321-324 are in first viewpoint 350 and second viewpoint 351. As such, the GPU processing or rendering the image or surface 300 including area 302 can utilize multiple viewpoints or multi-view rendering.

As indicated herein, GPUs or graphics processor units can use a tiled rendering architecture to reduce power consumption or save memory bandwidth. As further stated above, this rendering method can divide the scene into multiple bins, as well as include a visibility pass that identifies the triangles that are visible in each bin. Thus, in tiled rendering, a full screen can be divided into multiple bins or tiles. The scene can then be rendered multiple times, e.g., one or more times for each bin.

In aspects of graphics rendering, some graphics applications may render to a single target, i.e., a render target, one or more times. For instance, in graphics rendering, a frame buffer on a system memory may be updated multiple times. The frame buffer can be a portion of memory or random access memory (RAM), e.g., containing a bitmap or storage, to help store display data for a GPU. The frame buffer can also be a memory buffer containing a complete frame of data. Additionally, the frame buffer can be a logic buffer. In some aspects, updating the frame buffer can be performed in bin or tile rendering, where, as discussed above, a surface is divided into multiple bins or tiles and then each bin or tile can be separately rendered. Further, in tiled rendering, the frame buffer can be partitioned into multiple bins or tiles

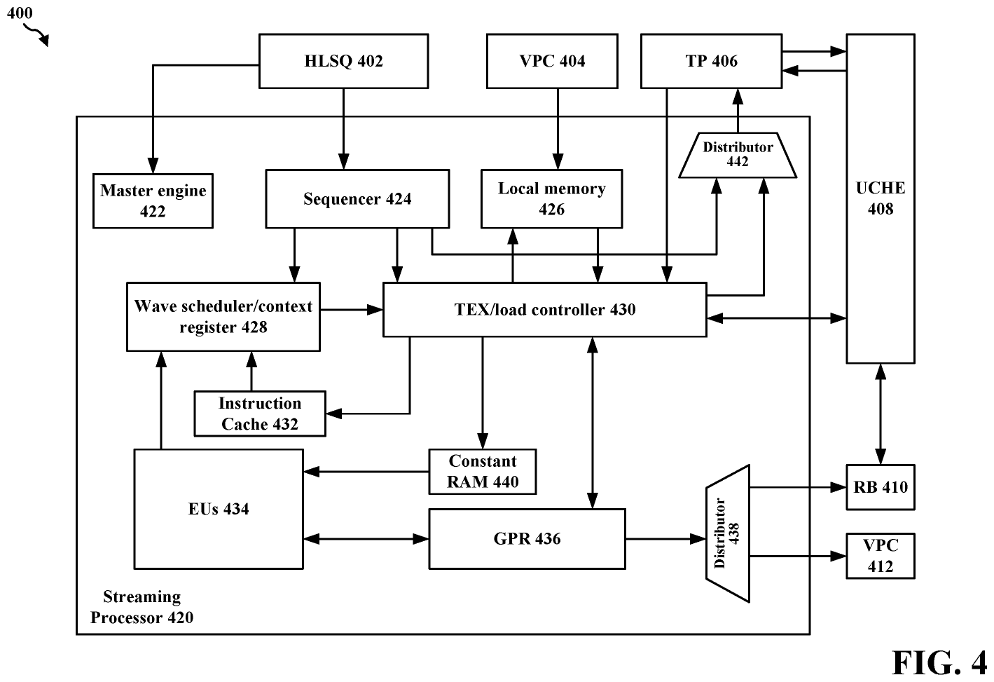

FIG. 4 illustrates an example GPU 400. More specifically, FIG. 4 illustrates a streaming processor (SP) system in GPU 400. As shown in FIG. 4, GPU 400 includes high level sequencer (HLSQ) 402, VPC 404, texture processor (TP) 406, UCHE 408, RB 410, and VPC 412. GPU 400 also includes SP 420, master engine 422, sequencer 424, local memory 426, wave scheduler and context register 428, texture (TEX) or load controller 430, instruction cache 432, execution units (EUs) 434, general purpose register (GPR) 436, texture distributor 438, constant RAM 440, and output distributor 442. The wave scheduler and context register 428 may include one or more wave slots.

As shown in FIG. 4, the SP 420 can include traditional function units or blocks, e.g., EUs 434 or sequencer 424. EUs 434 can execute or process some of the desired functions of the GPU. The sequencer 424 can allocate resources and local memory. Also, the sequencer 424 can allocate wave slots and any associated GPR 436 space. For example, the sequencer 424 can allocate wave slots or GPR 436 space when the HLSQ 402 issues a pixel tile workload to the SP 420. In some aspects, the wave scheduler 428 can execute a pixel shader or issue instructions to the EUs 434. The EUs 434 can also include an arithmetic logic unit (ALU) and/or an elementary function unit (EFU). Further, the TEX or load controller 430 can be considered an execution unit.

Moreover, the TEX or load controller 430 can correspond to one or multiple units. For instance, the TEX 430 can perform a texture fetch and/or the load controller 430 can perform a memory fetch. In some aspects, the instruction cache 432 can store a program to be executed. Also, the constant RAM 440 can store the constant that may be needed for a constant or uniform formation. As further shown in FIG. 4, the SP 420 can interface with the outside blocks, e.g., HLSQ 402, VPC 404, TP 406, UCHE 408, RB 410, and VPC 412. These blocks 402-412 can utilize user provided input and/or the SP can output results to these blocks or memory access.

As shown in FIG. 4, each unit or block in GPU 400 can send data or information to other blocks. For instance, HLSQ 402 can send commands to the master engine 422. Also, HLSQ 402 can send vertex threads, vertex attributes, pixel threads, and/or pixel attributes to the sequencer 424. VPC 404 can send certain coefficients to local memory 426. TP 406 can send texture data to the TEX 430. TP 406 can also receive texture requests from TEX 430, e.g., via output distributor 442, and bypass requests from local memory 426. Further, TP 406 can send requests to and receive texture elements (texels) from UCHE 408. UCHE 408 can also send memory to and receive memory from TEX 430, as well as send memory to and receive memory from RB 410. Also, RB 410 can receive an output in the form of color from GPR 436, e.g., via texture distributor 438. VPC 412 can also receive output in the form of vertices from GPR 436, e.g., via texture distributor 438. GPR 436 can also send temporary data to and receive temporary data from EUs 434. Moreover, EUs 434 can send address or predicate information to the wave scheduler 428, as well as receive constant data from constant RAM 440. TEX or load controller 430 can also send/receive load or store data to/from GPR 436, as well as send store data to, and receive load data from, local memory 426. Further, TEX or load controller 430 can send global data to constant RAM 440 and update information to the instruction cache 432. TEX or load controller 430 can also receive attribute data from sequencer 424 and synchronization information from wave scheduler 428. Additionally, wave scheduler 428 can receive decode information from instruction cache 432 and thread data from sequencer 424.

As mentioned above, the GPU 400 can process workloads, e.g., a pixel or vertex workload. In some aspects, these workloads can correspond to, or be referred to as, waves or wave formations. For instance, each workload or operation can use a group of vertices or pixels as a wave. For example, each wave can include 64 vertices or 128 pixels. In some instances, GPU 400 can send a wave formation, e.g., a pixel or vertex workload, to the wave scheduler 428 for execution. For a vertex workload, the GPU can perform a vertex transformation. For a pixel workload, the GPU can perform a pixel shading or lighting.

As indicated above, each of the aforementioned processes or workloads, e.g., the processes or workloads in the SP 420, can include a wave formation. For example, during a vertex workload, a number of vertices, e.g., three vertices, can form a triangle or primitive. The GPU can then perform a transformation of these vertices, such that the vertices can transform into a wave. In order to perform this transformation, GPUs can utilize a number of a wave slots, e.g., to help transform the vertices into a wave. Further, in order to execute a workload or program, the GPU can also allocate the GPR space, e.g., including a temporary register to store any temporary data. Additionally, the sequencer 424 can allocate the GPR 436 space and one or more wave slots in order to execute a wave. For example, the GPR 436 space and one or more wave slots can be allocated when a pixel or vertex workload is issued.

In some aspects, the wave scheduler 428 can process a pixel workload and/or issue instructions to various execution units, e.g., EUs 434. The wave scheduler 428 can also help to ensure data dependency between instructions, e.g., data dependency between ALU operands due to the pipeline latency and/or texture sample return data dependency based on a synchronization mechanism.

As shown in FIG. 4 above, GPUs may utilize a streaming processor (SP) 420, e.g., a sequencer 424 in SP 420, to allocate different workloads to different wave slots. For instance, sequencer 424 may allocate wave slots and associated general purpose register (GPR) space for workloads, e.g., a high level sequencer (HLSQ) issue pixel tile workload (i/j barycentric coefficient data), to SP 420. Next, a wave scheduler 428 may execute a pixel shader and issue instructions to execution units (EUs) 434, e.g., arithmetic logic unit (ALU), elementary function unit (EFU), texture (TEX) or load controller (LOAD). After the shader processing is complete, the SP 420 may dispatch the processed result (i.e., mostly color) to a downstream block (e.g., a render backend (RB) 410). In some aspects, the output order of this process may be the same as the input order, which may be a functional specification. The SP 420 may work efficiently because wave slots that accept and execute a workload earlier may generally finish processing the workload earlier.

However, there are some applications (e.g., a path trace test feature, complex lighting (shadow), or three dimensional (3D) special effects) that may depend on memory fetch data test results. For example, for high level shaders in graphics processing, e.g., a Graphics bench mark, a shader may continue issuing texture sample instructions until the results meet a threshold. This may cause a high amount of complex instructions/paths, and most instructions/paths may have memory fetched inside this loop, which causes a pixel/wave execution cycle to vary drastically (e.g., 8 multiples away from simulations). This may also result in waves completing execution in a non-linear or non-sequential order, i.e., wave slots finish executing workloads out-of-order compared to the workload order. For wave slots executing certain instructions, e.g., a pixel warp, that complete execution early, the wave slot may wait until wave slots with a higher priority order complete execution and dispatch the result. These wave slots may then retire and are ready for a new workload. As such, there may be a large amount of time wasted for wave slots that finish executing an instruction/workload before wave slots with a higher priority.

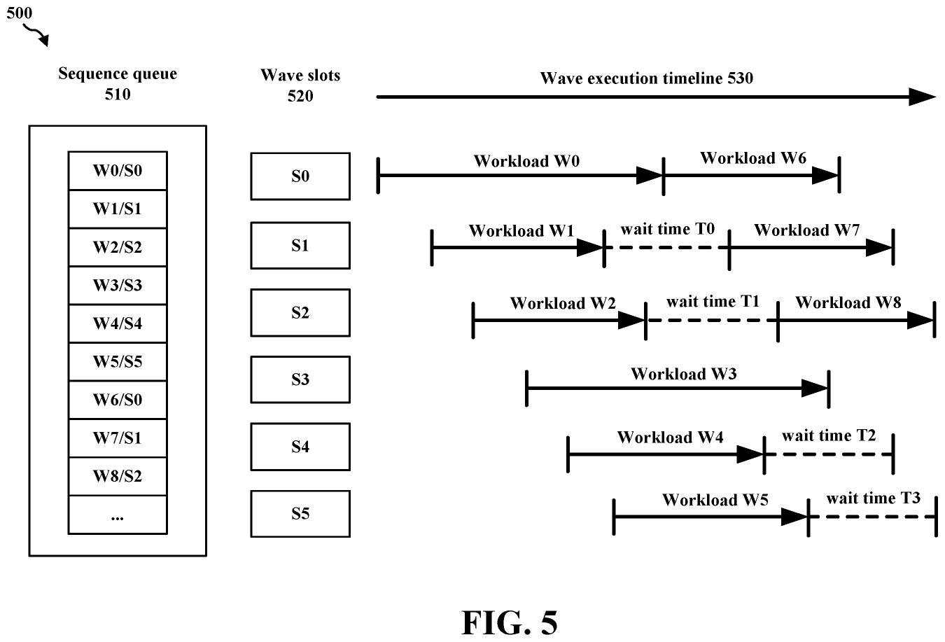

FIG. 5 illustrates a diagram 500 of a sequence queue and wave slots for executing incoming workloads. As shown in FIG. 5, diagram 500 includes a sequence queue 510 for incoming workloads, a number of wave slots 520, and a wave execution timeline 530. In some instances, diagram 500 may illustrate the action at a sequencer of a SP, which may utilize the sequence queue to keep track of incoming workloads in a wave input order and its corresponding wave slot identifier (ID). For example, as illustrated in FIG. 5, there are six wave slots (S0-S5) allocated for nine incoming workloads (W0-W8), e.g., each workload may be a pixel warp.

As shown in FIG. 5, an oldest workload (workload W0), e.g., a pixel warp, in wave slot S0 may take a longer run time to complete execution compared to newer workloads. For example, workload W1 and workload W2 may complete execution before workload W0 completes execution. As a result, the wave slots for workload W1 (wave slot S1) and workload W2 (wave slot S2) may wait for workload W0 to complete execution and dispatch the result. This is shown in FIG. 5 as wait times T0 and T1 at wave slots S1 and S2, respectively. Accordingly, this results in wave slots S1 and S2 wasting time while waiting for workload W0 to finished executing, rather than being used immediately for any incoming workloads. As such, wave slots S1 and S2 are allocated workloads W7 and W8 after wave slot S0 is allocated workload W6. FIG. 5 also depicts that wave slots S4 and S5 include wait times T2 and T3, respectively.

Based on the above, it may be beneficial to allocate workloads to wave slots based on the availability of wave slots. By doing so, wave slots may reduce the amount of time spent waiting for other wave slots to execute workloads/instructions. Additionally, by allocating workloads to wave slots based on wave slot availability, wave slots may be more efficiently utilized to handle incoming workloads. For instance, it may be beneficial to allocate workloads to wave slots based on when certain wave slots complete execution, rather than allocating workloads to wave slots in a linear or sequential order. Accordingly, it may be beneficial to allocate and execute workloads in a non-linear or non-sequential order.

Aspects of the present disclosure may allocate workloads to wave slots based on the availability of wave slots. As such, aspects of the present disclosure may help to reduce the amount of time wave slots spend waiting for other wave slots to execute workloads/instructions. Further, by allocating workloads to wave slots based on wave slot availability, aspects of the present disclosure may more efficiently utilize wave slots to handle incoming workloads. For example, aspects of the present disclosure may allocate workloads to wave slots based on when certain wave slots complete execution, rather than allocating workloads to wave slots in a linear or sequential order. Therefore, aspects of the present disclosure may allocate and execute workloads in a non-linear or non-sequential order.

In some instances, aspects of the present disclosure may provide an efficient manner in which to utilize GPR space at a streaming processor (SP). Aspects of the present disclosure may also manage a sequence queue at an eviction buffer to retire wave slots and corresponding GPR space for incoming workloads. Additionally, aspects of the present disclosure may allow for such a wave slot retirement management system at a negligible cost when wave slots complete execution in a non-linear or non-sequential manner. That is, aspects of the present disclosure may allow for wave slots to finish executing workloads outside of a wave slot order or wave slot priority.

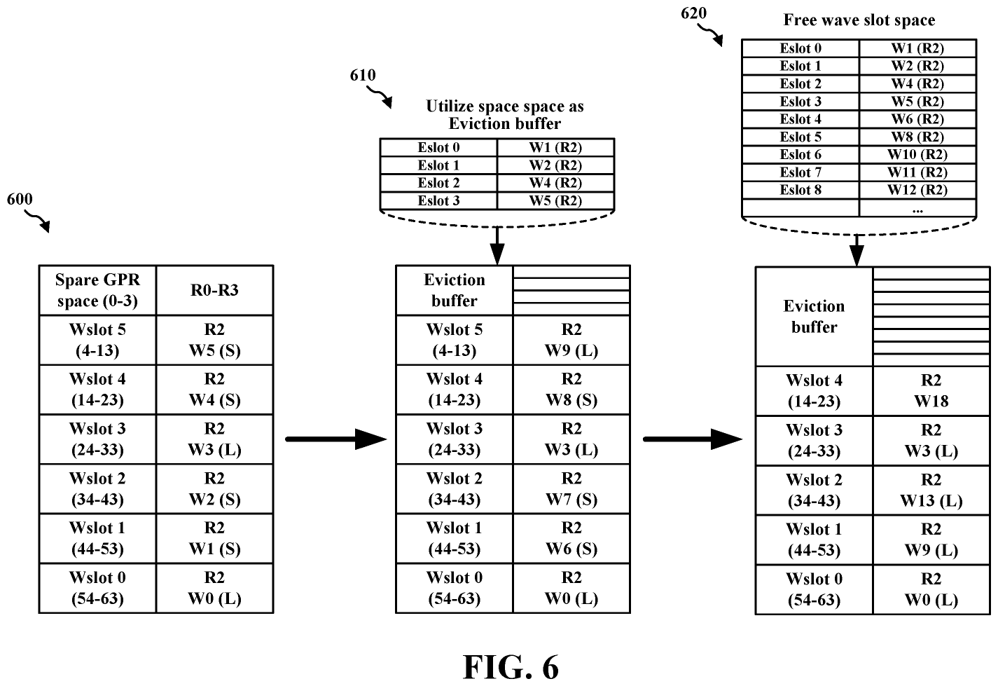

FIG. 6 illustrates diagram 600, 610, and 620 of a wave slot allocation and corresponding GPR space at a GPU. As shown in FIG. 6, diagram 600 illustrates one example of how a sequencer at an SP may allocate wave slots and corresponding GPR space. For instance, using the aforementioned shaders, each wave slot may occupy 10 GPR spaces/units (e.g., R0-R9), where one GPR space/unit (e.g., R2) is used to store a certain result, e.g., a color result. As such, after allocating six (6) wave slots for a certain workload, e.g., a pixel warp, which occupies 60 GPR spaces, there may be four (4) spare GPR spaces left, e.g., GPR spaces 0-3. In some instances, the total GPR spaces available may be 64 spaces/units, e.g., GPR spaces 0-63. As GPR spaces 0-3 may be spare spaces, wave slot 5 may occupy GPR spaces 4-13, wave slot 4 may occupy GPR spaces 14-23, wave slot 3 may occupy GPR spaces 24-33, wave slot 2 may occupy GPR spaces 34-43, wave slot 1 may occupy GPR spaces 44-53, and wave slot 0 may occupy GPR spaces 54-63.

As illustrated in FIG. 6, diagram 610 depicts that a sequencer at an SP may create an eviction buffer and eviction slots by utilizing a certain amount of GPR space, e.g., four spare GPR spaces. In some instances, when a certain workload is complete, e.g., workload W1, another workload may still be executing, e.g., workload W0. When this occurs, the SP scheduler may copy a result of workload W1, e.g., a pixel warp, to an eviction buffer slot, e.g., Eslot 0, after determining that workload W0 is still in the middle of execution. By doing so, wave slot 1 can be released early to process incoming workload W4. The same process can be performed for workload W2 and incoming workload W6. After a scheduler copies the result to the eviction buffer, the scheduler may notify the sequencer to update a corresponding sequence queue entry to an eviction buffer slot. As such, an SP dispatcher may determine where to fetch and output a correct result, e.g., a color result, to a downstream block in order.

As depicted in FIG. 6, diagram 620 demonstrates that after all current eviction slots are occupied, e.g., Eslots 0-3, a sequencer may determine that there are still wave slots completing shader execution in a non-sequential order, i.e., out-of-order, and waiting to output the result. After doing so, the sequencer may communicate with an SP scheduler to surrender 10 GPR spaces/units for a wave slot and create 10 more eviction buffer slots, e.g., Eslots 4-13, in order to store a workload result, e.g., a color result, from wave slots that already completed shader execution. In some instances, when the eviction buffer is not fully utilized and a wave slot becomes fully utilized, the SP sequencer and the scheduler may reverse the eviction buffer space back into wave slot space. Accordingly, aspects of the present disclosure may convert wave slot space into eviction buffer space to temporarily store workload results. This may help to process workloads in a timely fashion and also allow aspects of the present disclosure to process workloads in a non-sequential manner.

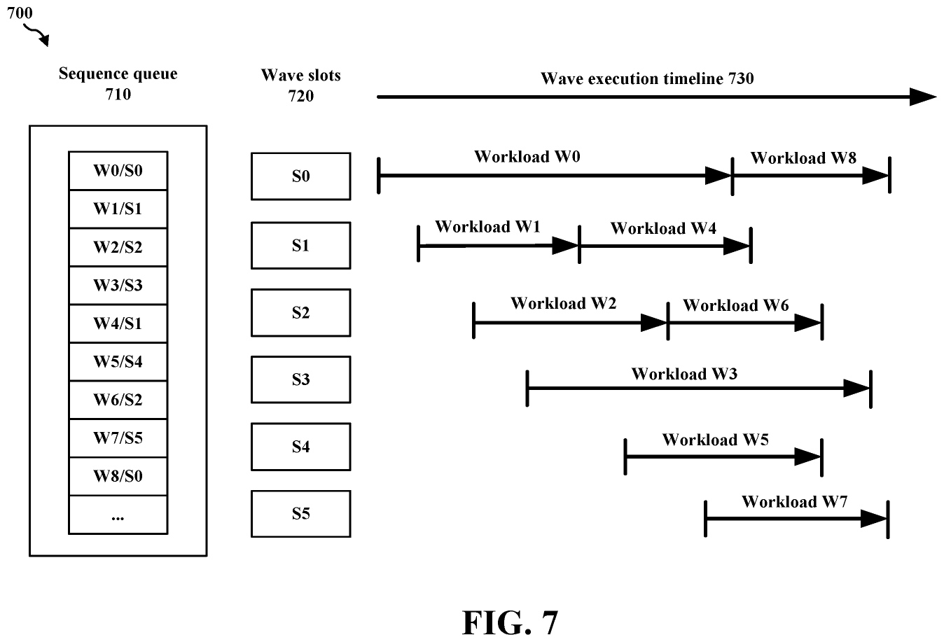

FIG. 7 illustrates a diagram 700 of a sequence queue and wave slots for executing incoming workloads. As shown in FIG. 7, diagram 700 includes a sequence queue 710 for incoming workloads, a number of wave slots 720, and a wave execution timeline 730. More specifically, diagram 700 depicts the aforementioned wave retirement process in aspects of the present disclosure. As illustrated in FIG. 7, workloads may be allocated to wave slots in a non-sequential order, such that previously-allocated wave slots may be prioritized for workload allocation over a next sequential wave slot. Accordingly, upon finishing the execution of a workload at a previously-allocated wave slot, a subsequent workload may be allocated to the previously-allocated wave slot and begin execution.

As shown in FIG. 7, workload W0, e.g., a pixel warp, may still be executing at wave slot S0 after workload W1 is finished executing at wave slot S1. After determining that workload W0 is still in the middle of execution, a scheduler at an SP may copy a result of the workload W1, e.g., a pixel warp, to an eviction buffer slot. By doing so, wave slot S1 may be released early for the allocation of the next incoming workload, e.g., workload W4. That is, this allocation of workload W4 may occur after workload W3 is allocated to wave slot S3, such that workload W4 is allocated to wave slot S1, rather than allocated to wave slot S4 (which is in sequential order), because the workload W1 result (in R2) may be copied to Eslot 0 (E0), in sequence queue 710, workload W1 may update the queue information to indicate that the result is stored in E0. The same process may be performed once workload W2 finishes executing at wave slot S2, after copying the workload W2 result (in R2) to Eslot 2 (E2), then incoming workload W6 may be allocated to wave slot S2 and begin execution at wave slot S2 (rather than be allocated to wave slot S5 in sequential order). By doing so, upon finishing executing a workload, wave slots S1 and S2 may be immediately allocated a subsequent workload and may not waste any time waiting for a sequential allocation of workloads in sequential order. Therefore, aspects of the present disclosure may efficiently utilize memory space, e.g., GPR space, which can in turn increase the processing speed/efficiency at the GPU. As such, aspects of the present disclosure may increase the workload processing capability/speed at a GPU, e.g., the amount of frames-per-second (FPS) that are processed.

Aspects of the present disclosure may identify spare GPR space in which to store the result of workloads that have finished executing. That is, aspects of the present disclosure may copy the result of an executed workload to an eviction buffer in order to efficiently utilize memory space. After this, the wave slot and GPR space may be released to process/execute subsequent workloads. These wave slots may finish executing a workload and then be allocated a new workload in a non-linear or non-sequential fashion. As such, wave slots may not be forced to wait for another wave slot to finish executing a workload. In turn, this can increase the processing speed/efficiency at the GPU. So aspects of the present disclosure may utilize existing storage space, e.g., spare GPR space or re-partitioned GPR space, to store workload results. Therefore, when a workload or wave finishes processing/executing at a particular wave slot, the result of the workload execution may be copied to an eviction buffer and a subsequent workload can be immediately allocated to that particular wave slot. For instance, a portion of the GPR space may be re-partitioned as an eviction buffer in order to store the result of executed workloads, such that there is an increased capability to efficiently process workloads.

Aspects of the present disclosure may process workloads at wave slots in a non-sequential manner, such that subsequent workloads may be immediately processed at previously-allocated wave slots. For instance, rather than waiting to be processed at a sequential wave slot, subsequent workloads can be immediately processed at previously-allocated wave slots. Additionally, by copying the data into the eviction buffer, aspects of the present disclosure may free up memory or buffer space for new workloads. By doing so, aspects of the present disclosure may achieve memory efficiency and save storage space, e.g., at the general purpose register (GPR). Accordingly, the non-linear or non-sequential wave slot retirement in aspects of the present disclosure may efficiently utilize memory space and/or save storage space. Moreover, aspects of the present disclosure may significantly increase the amount of processing capability at a GPU, e.g., the amount of FPS that are processed.

The aforementioned wave retirement process in aspects of the present disclosure provides an efficient way to utilize GPR space and a sequence queue, e.g., in an SP of a GPU. For instance, aspects of the present disclosure may utilize an eviction buffer to retire or free up wave slots and corresponding GPR space for new workloads. This may be accomplished with a negligible cost when workloads complete execution at wave slots in a non-sequential order. At least one advantage of the aforementioned process is to efficiently utilize memory space and/or save storage space, e.g., GPR space. Further, aspects of the present disclosure may increase the amount of processing capability at a GPU, e.g., an amount of frames-per-second (FPS) that can be processed at a GPU.

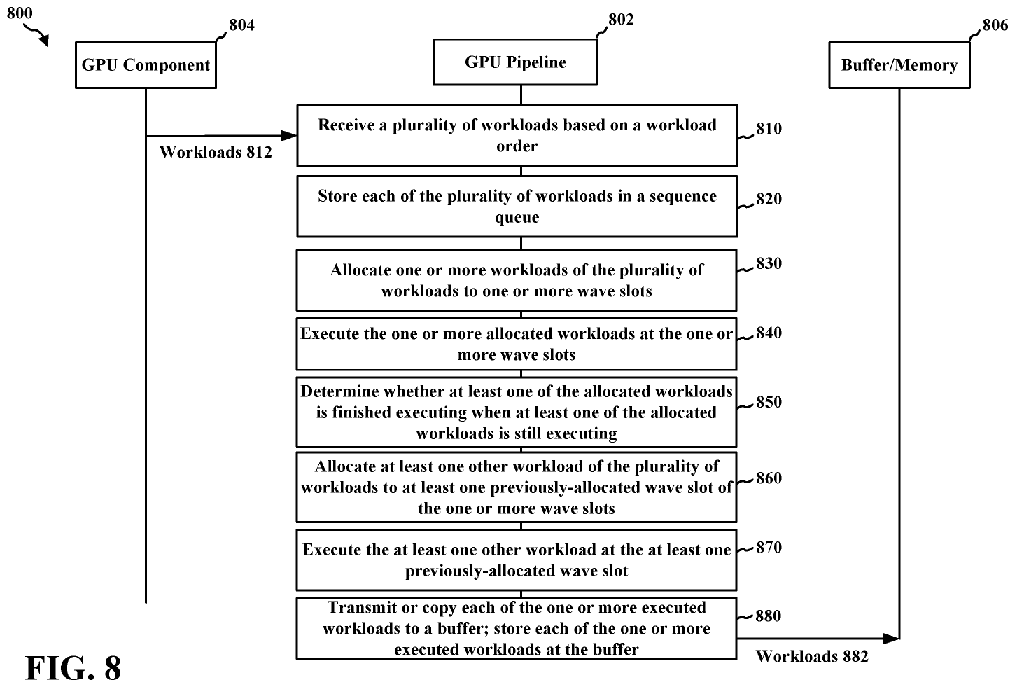

FIG. 8 is a communication flow diagram 800 of graphics processing in accordance with one or more techniques of this disclosure. As shown in FIG. 8, diagram 800 includes example communications between GPU pipeline 802 (e.g., an SP in a GPU pipeline), GPU component 804 (e.g., another component in a GPU pipeline), and buffer or memory 806, in accordance with one or more techniques of this disclosure.

At 810, GPU pipeline 802 may receive a plurality of workloads, e.g., workloads 812, based on a workload order, each of the plurality of workloads being received in the workload order including at least a first workload and a second workload. For example, GPU pipeline 802 may receive workloads 812 from GPU component 804. Each of the plurality of workloads, e.g., workloads 812, may correspond to at least one of a pixel workload, a pixel warp, or a vertex workload. Also, at least one of the pixel workload, the pixel warp, or the vertex workload may be associated with at least one of a shader program, a pixel program, or a vertex program. Each of the plurality of workloads, e.g., workloads 812, may include at least one of one or more graphics instructions or one or more shader instructions. Moreover, the workload order may correspond to a priority of the plurality of workloads.

At 820, GPU pipeline 802 may store, upon receiving the plurality of workloads, each of the plurality of workloads in a sequence queue, where each of the plurality of workloads, e.g., workloads 812, are stored in the sequence queue based on the workload order.

At 830, GPU pipeline 802 may allocate, based on the workload order, one or more workloads of the plurality of workloads, e.g., workloads 812, to one or more wave slots of a plurality of wave slots, such that at least the first workload is allocated to a first wave slot of the plurality of wave slots and the second workload is allocated to a second wave slot of the plurality of wave slots. Additionally, the one or more workloads may be allocated to the one or more wave slots by a streaming processor (SP) of a graphics processing unit (GPU).

At 840, GPU pipeline 802 may execute the one or more allocated workloads at the one or more wave slots, such that at least the first workload is executed at the first wave slot and the second workload is executed at the second wave slot.

At 850, GPU pipeline 802 may determine whether at least one of the one or more allocated workloads is finished executing when at least one of the one or more allocated workloads is still executing. In some aspects, the at least one other workload may be allocated to the at least one previously-allocated wave slot if at least one of the one or more allocated workloads is finished executing when at least one of the one or more allocated workloads is still executing. Also, the at least one allocated workload that is finished executing may be subsequent to the at least one allocated workload that is still executing in the workload order.

At 860, GPU pipeline 802 may allocate, upon finishing executing at least one of the one or more allocated workloads, at least one other workload of the plurality of workloads to at least one previously-allocated wave slot of the one or more wave slots, the at least one previously-allocated wave slot having executed at least one of the one or more allocated workloads. In some instances, the at least one other workload may be allocated to the at least one previously-allocated wave slot based on the workload order. Also, the at least one other workload may be subsequent to the one or more workloads in the workload order, such that the at least one other workload may be received after the one or more workloads.

In some aspects, the first workload may be an earliest-received workload in the workload order, the second workload may be a second earliest-received workload in the workload order, a third workload may be a third earliest-received workload in the workload order, and a fourth workload may be a fourth earliest-received workload in the workload order. Further, the at least one other workload may include at least one of the third workload or the fourth workload, such that at least one of the third workload or the fourth workload may be allocated to at least one of the first wave slot or the second wave slot upon finishing executing at least one of the first workload or the second workload.

At 870, GPU pipeline 802 may execute, upon allocating the at least one other workload to the at least one previously-allocated wave slot, the at least one other workload at the at least one previously-allocated wave slot.

At 880, GPU pipeline 802 may transmit or copy each of the one or more executed workloads, e.g., workloads 882, to a buffer 806 or an eviction buffer; and store each of the one or more executed workloads, e.g., workloads 882, at the buffer 806 or the eviction buffer. A portion of a general purpose register (GPR) may be partitioned for the eviction buffer, such that each of the one or more executed workloads, e.g., workloads 882, may be transmitted or copied to the partitioned portion of the GPR.

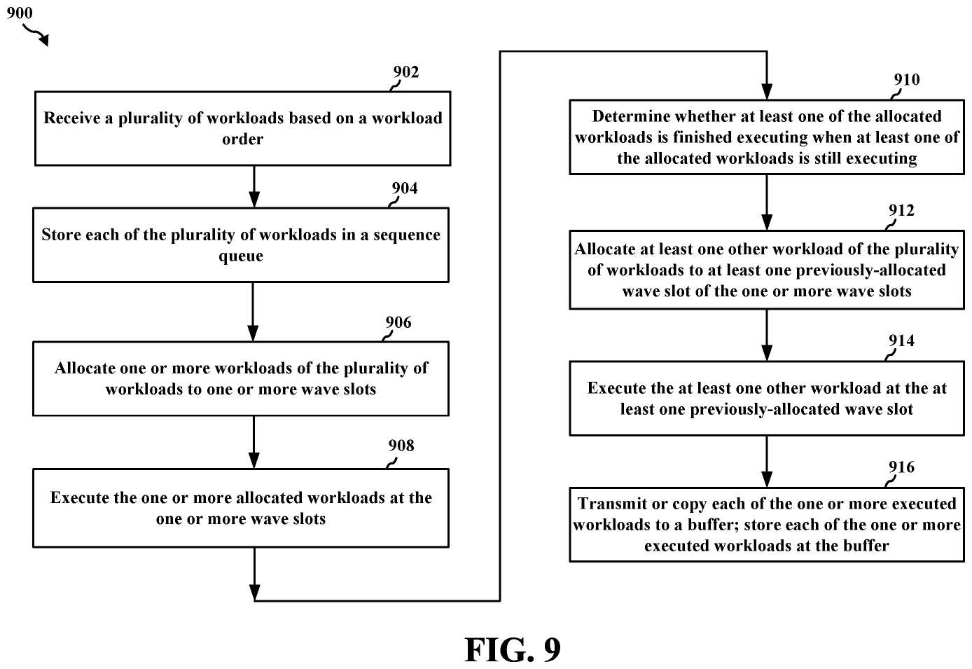

FIG. 9 is a flowchart 900 of an example method of graphics processing in accordance with one or more techniques of this disclosure. The method may be performed by an apparatus, such as an apparatus for graphics processing, a GPU, another graphics processor, a GPU pipeline, a wireless communication device, and/or any apparatus that can perform graphics processing as used in connection with the examples of FIGS. 1-8.

At 902, the apparatus may receive a plurality of workloads based on a workload order, each of the plurality of workloads being received in the workload order including at least a first workload and a second workload. For example, as described in 810 of FIG. 8, GPU pipeline 802 may receive a plurality of workloads based on a workload order, each of the plurality of workloads being received in the workload order including at least a first workload and a second workload. Further, processing unit 120 in FIG. 1 may perform step 902. Each of the plurality of workloads may correspond to at least one of a pixel workload, a pixel warp, or a vertex workload. Also, at least one of the pixel workload, the pixel warp, or the vertex workload may be associated with at least one of a shader program, a pixel program, or a vertex program. Each of the plurality of workloads may include at least one of one or more graphics instructions or one or more shader instructions. Moreover, the workload order may correspond to a priority of the plurality of workloads.

At 904, the apparatus may store, upon receiving the plurality of workloads, each of the plurality of workloads in a sequence queue, where each of the plurality of workloads are stored in the sequence queue based on the workload order. For example, as described in 820 of FIG. 8, GPU pipeline 802 may store, upon receiving the plurality of workloads, each of the plurality of workloads in a sequence queue, where each of the plurality of workloads are stored in the sequence queue based on the workload order. Further, processing unit 120 in FIG. 1 may perform step 904.

At 906, the apparatus may allocate, based on the workload order, one or more workloads of the plurality of workloads to one or more wave slots of a plurality of wave slots, such that at least the first workload is allocated to a first wave slot of the plurality of wave slots and the second workload is allocated to a second wave slot of the plurality of wave slots. For example, as described in 830 of FIG. 8, GPU pipeline 802 may allocate, based on the workload order, one or more workloads of the plurality of workloads to one or more wave slots of a plurality of wave slots, such that at least the first workload is allocated to a first wave slot of the plurality of wave slots and the second workload is allocated to a second wave slot of the plurality of wave slots. Further, processing unit 120 in FIG. 1 may perform step 906. Additionally, the one or more workloads may be allocated to the one or more wave slots by a streaming processor (SP) of a graphics processing unit (GPU).

At 908, the apparatus may execute the one or more allocated workloads at the one or more wave slots, such that at least the first workload is executed at the first wave slot and the second workload is executed at the second wave slot. For example, as described in 840 of FIG. 8, GPU pipeline 802 may execute the one or more allocated workloads at the one or more wave slots, such that at least the first workload is executed at the first wave slot and the second workload is executed at the second wave slot. Further, processing unit 120 in FIG. 1 may perform step 908.

At 910, the apparatus may determine whether at least one of the one or more allocated workloads is finished executing when at least one of the one or more allocated workloads is still executing. For example, as described in 850 of FIG. 8, GPU pipeline 802 may determine whether at least one of the one or more allocated workloads is finished executing when at least one of the one or more allocated workloads is still executing. Further, processing unit 120 in FIG. 1 may perform step 910. In some aspects, the at least one other workload may be allocated to the at least one previously-allocated wave slot if at least one of the one or more allocated workloads is finished executing when at least one of the one or more allocated workloads is still executing.

Also, the at least one allocated workload that is finished executing may be subsequent to the at least one allocated workload that is still executing in the workload order.

At 912, the apparatus may allocate, upon finishing executing at least one of the one or more allocated workloads, at least one other workload of the plurality of workloads to at least one previously-allocated wave slot of the one or more wave slots, the at least one previously-allocated wave slot having executed at least one of the one or more allocated workloads. For example, as described in 860 of FIG. 8, GPU pipeline 802 may allocate, upon finishing executing at least one of the one or more allocated workloads, at least one other workload of the plurality of workloads to at least one previously-allocated wave slot of the one or more wave slots, the at least one previously-allocated wave slot having executed at least one of the one or more allocated workloads. Further, processing unit 120 in FIG. 1 may perform step 912. In some instances, the at least one other workload may be allocated to the at least one previously-allocated wave slot based on the workload order. Also, the at least one other workload may be subsequent to the one or more workloads in the workload order, such that the at least one other workload may be received after the one or more workloads.

In some aspects, the first workload may be an earliest-received workload in the workload order, the second workload may be a second earliest-received workload in the workload order, a third workload may be a third earliest-received workload in the workload order, and a fourth workload may be a fourth earliest-received workload in the workload order. Further, the at least one other workload may include at least one of the third workload or the fourth workload, such that at least one of the third workload or the fourth workload may be allocated to at least one of the first wave slot or the second wave slot upon finishing executing at least one of the first workload or the second workload.

At 914, the apparatus may execute, upon allocating the at least one other workload to the at least one previously-allocated wave slot, the at least one other workload at the at least one previously-allocated wave slot. For example, as described in 870 of FIG. 8, GPU pipeline 802 may execute, upon allocating the at least one other workload to the at least one previously-allocated wave slot, the at least one other workload at the at least one previously-allocated wave slot. Further, processing unit 120 in FIG. 1 may perform step 914.

At 916, the apparatus may transmit or copy each of the one or more executed workloads to a buffer or an eviction buffer; and store each of the one or more executed workloads at the buffer or the eviction buffer. For example, as described in 880 of FIG. 8, GPU pipeline 802 may transmit or copy each of the one or more executed workloads to a buffer or an eviction buffer; and store each of the one or more executed workloads at the buffer or the eviction buffer. Further, processing unit 120 in FIG. 1 may perform step 916. A portion of a general purpose register (GPR) may be partitioned for the eviction buffer, such that each of the one or more executed workloads may be transmitted or copied to the partitioned portion of the GPR.

In configurations, a method or an apparatus for graphics processing is provided. The apparatus may be a GPU, a graphics processor, or some other processor that may perform graphics processing. In aspects, the apparatus may be the processing unit 120 within the device 104, or may be some other hardware within the device 104 or another device. The apparatus, e.g., processing unit 120, may include means for receiving a plurality of workloads based on a workload order, each of the plurality of workloads being received in the workload order including at least a first workload and a second workload; means for allocating, based on the workload order, one or more workloads of the plurality of workloads to one or more wave slots of a plurality of wave slots, such that at least the first workload is allocated to a first wave slot of the plurality of wave slots and the second workload is allocated to a second wave slot of the plurality of wave slots; means for executing the one or more allocated workloads at the one or more wave slots, such that at least the first workload is executed at the first wave slot and the second workload is executed at the second wave slot; means for allocating, upon finishing executing at least one of the one or more allocated workloads, at least one other workload of the plurality of workloads to at least one previously-allocated wave slot of the one or more wave slots, the at least one previously-allocated wave slot having executed at least one of the one or more allocated workloads; means for storing, upon receiving the plurality of workloads, each of the plurality of workloads in a sequence queue, where each of the plurality of workloads are stored in the sequence queue based on the workload order; means for determining whether at least one of the one or more allocated workloads is finished executing when at least one of the one or more allocated workloads is still executing; means for transmitting or copying each of the one or more executed workloads to a buffer or an eviction buffer; means for storing each of the one or more executed workloads at the buffer or the eviction buffer; and means for executing, upon allocating the at least one other workload to the at least one previously-allocated wave slot, the at least one other workload at the at least one previously-allocated wave slot.

The subject matter described herein can be implemented to realize one or more benefits or advantages. For instance, the described graphics processing techniques can be used by a GPU, a graphics processor, or some other processor that can perform graphics processing to implement the non-sequential wave slot retirement techniques described herein. This can also be accomplished at a low cost compared to other graphics processing techniques. Moreover, the graphics processing techniques herein can improve or speed up data processing or execution. Further, the graphics processing techniques herein can improve resource or data utilization and/or resource efficiency. Additionally, aspects of the present disclosure can utilize non-sequential wave slot retirement in order to improve memory bandwidth efficiency and/or increase processing speed at a GPU.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects.

Unless specifically stated otherwise, the term “some” refers to one or more and the term “or” may be interpreted as “and/or” where context does not dictate otherwise. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium.

In accordance with this disclosure, the term “or” may be interpreted as “and/or” where context does not dictate otherwise. Additionally, while phrases such as “one or more” or “at least one” or the like may have been used for some features disclosed herein but not others, the features for which such language was not used may be interpreted to have such a meaning implied where context does not dictate otherwise.

In one or more examples, the functions described herein may be implemented in hardware, software, firmware, or any combination thereof. For example, although the term “processing unit” has been used throughout this disclosure, such processing units may be implemented in hardware, software, firmware, or any combination thereof. If any function, processing unit, technique described herein, or other module is implemented in software, the function, processing unit, technique described herein, or other module may be stored on or transmitted over as one or more instructions or code on a computer-readable medium. Computer-readable media may include computer data storage media or communication media including any medium that facilitates transfer of a computer program from one place to another. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. By way of example, and not limitation, such computer-readable media can comprise RAM, ROM, EEPROM, CD-ROM or other optical disk storage, magnetic disk storage or other magnetic storage devices. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media. A computer program product may include a computer-readable medium.

The code may be executed by one or more processors, such as one or more digital signal processors (DSPs), general purpose microprocessors, application specific integrated circuits (ASICs), arithmetic logic units (ALUs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs, e.g., a chip set. Various components, modules or units are described in this disclosure to emphasize functional aspects of devices configured to perform the disclosed techniques, but do not necessarily need realization by different hardware units. Rather, as described above, various units may be combined in any hardware unit or provided by a collection of inter-operative hardware units, including one or more processors as described above, in conjunction with suitable software and/or firmware. Accordingly, the term “processor,” as used herein may refer to any of the foregoing structure or any other structure suitable for implementation of the techniques described herein. Also, the techniques may be fully implemented in one or more circuits or logic elements.

The following aspects are illustrative only and may be combined with other aspects or teachings described herein, without limitation.

Aspect 1 is a method of graphics processing. The method includes receiving a plurality of workloads based on a workload order, each of the plurality of workloads being received in the workload order including at least a first workload and a second workload; allocating, based on the workload order, one or more workloads of the plurality of workloads to one or more wave slots of a plurality of wave slots, such that at least the first workload is allocated to a first wave slot of the plurality of wave slots and the second workload is allocated to a second wave slot of the plurality of wave slots; executing the one or more allocated workloads at the one or more wave slots, such that at least the first workload is executed at the first wave slot and the second workload is executed at the second wave slot; and allocating, upon finishing executing at least one of the one or more allocated workloads, at least one other workload of the plurality of workloads to at least one previously-allocated wave slot of the one or more wave slots, the at least one previously-allocated wave slot having executed at least one of the one or more allocated workloads.

Aspect 2 is the method of aspect 1, further including storing, upon receiving the plurality of workloads, each of the plurality of workloads in a sequence queue, where each of the plurality of workloads are stored in the sequence queue based on the workload order.

Aspect 3 is the method of any of aspects 1 and 2, further including determining whether at least one of the one or more allocated workloads is finished executing when at least one of the one or more allocated workloads is still executing.

Aspect 4 is the method of any of aspects 1 to 3, where the at least one other workload is allocated to the at least one previously-allocated wave slot if at least one of the one or more allocated workloads is finished executing when at least one of the one or more allocated workloads is still executing.

Aspect 5 is the method of any of aspects 1 to 4, where the at least one allocated workload that is finished executing is subsequent to the at least one allocated workload that is still executing in the workload order.

Aspect 6 is the method of any of aspects 1 to 5, further including transmitting or copying each of the one or more executed workloads to a buffer or an eviction buffer.

Aspect 7 is the method of any of aspects 1 to 6, further including storing each of the one or more executed workloads at the buffer or the eviction buffer.

Aspect 8 is the method of any of aspects 1 to 7, where a portion of a general purpose register (GPR) is partitioned for the eviction buffer, such that each of the one or more executed workloads is transmitted or copied to the partitioned portion of the GPR.

Aspect 9 is the method of any of aspects 1 to 8, further including executing, upon allocating the at least one other workload to the at least one previously-allocated wave slot, the at least one other workload at the at least one previously-allocated wave slot.

Aspect 10 is the method of any of aspects 1 to 9, where the at least one other workload is allocated to the at least one previously-allocated wave slot based on the workload order.

Aspect 11 is the method of any of aspects 1 to 10, where the at least one other workload is subsequent to the one or more workloads in the workload order, such that the at least one other workload is received after the one or more workloads.

Aspect 12 is the method of any of aspects 1 to 11, where the first workload is an earliest-received workload in the workload order, the second workload is a second earliest-received workload in the workload order, a third workload is a third earliest-received workload in the workload order, and a fourth workload is a fourth earliest-received workload in the workload order.

Aspect 13 is the method of any of aspects 1 to 12, where the at least one other workload includes at least one of the third workload or the fourth workload, such that at least one of the third workload or the fourth workload is allocated to at least one of the first wave slot or the second wave slot upon finishing executing at least one of the first workload or the second workload.

Aspect 14 is the method of any of aspects 1 to 13, where each of the plurality of workloads corresponds to at least one of a pixel workload, a pixel warp, or a vertex workload.

Aspect 15 is the method of any of aspects 1 to 14, where at least one of the pixel workload, the pixel warp, or the vertex workload is associated with at least one of a shader program, a pixel program, or a vertex program.

Aspect 16 is the method of any of aspects 1 to 15, where each of the plurality of workloads includes at least one of one or more graphics instructions or one or more shader instructions.

Aspect 17 is the method of any of aspects 1 to 16, where the workload order corresponds to a priority of the plurality of workloads.

Aspect 18 is the method of any of aspects 1 to 17, where the one or more workloads are allocated to the one or more wave slots by a streaming processor (SP) of a graphics processing unit (GPU).

Aspect 19 is an apparatus for graphics processing including at least one processor coupled to a memory and configured to implement a method as in any of aspects 1 to 18.

Aspect 20 is an apparatus for graphics processing including means for implementing a method as in any of aspects 1 to 18.

Aspect 21 is a computer-readable medium storing computer executable code, the code when executed by at least one processor causes the at least one processor to implement a method as in any of aspects 1 to 18.

What is claimed is:

1. An apparatus for graphics processing, comprising:
a memory; and
at least one processor coupled to the memory and configured to:
receive a plurality of workloads based on a workload order, each of the plurality of workloads being received in the workload order including at least a first workload and a second workload;
allocate, based on the workload order, one or more workloads of the plurality of workloads to one or more wave slots of a plurality of wave slots, such that at least the first workload is allocated to a first wave slot of the plurality of wave slots and the second workload is allocated to a second wave slot of the plurality of wave slots;
execute the one or more allocated workloads at the one or more wave slots, such that at least the first workload is executed at the first wave slot and the second workload is executed at the second wave slot; and
allocate, upon finishing executing at least one of the one or more allocated workloads, at least one other workload of the plurality of workloads to at least one previously-allocated wave slot of the one or more wave slots, the at least one previously-allocated wave slot having executed at least one of the one or more allocated workloads.

2. The apparatus of claim 1, wherein the at least one processor is further configured to:
store, upon receiving the plurality of workloads, each of the plurality of workloads in a sequence queue, wherein each of the plurality of workloads are stored in the sequence queue based on the workload order.

3. The apparatus of claim 1, wherein the at least one processor is further configured to:
determine whether at least one of the one or more allocated workloads is finished executing when at least one of the one or more allocated workloads is still executing.

4. The apparatus of claim 3, wherein the at least one other workload is allocated to the at least one previously-allocated wave slot if at least one of the one or more allocated workloads is finished executing when at least one of the one or more allocated workloads is still executing.

5. The apparatus of claim 3, wherein the at least one allocated workload that is finished executing is subsequent to the at least one allocated workload that is still executing in the workload order.

6. The apparatus of claim 1, wherein the at least one processor is further configured to:
transmit or copy each of the one or more executed workloads to a buffer or an eviction buffer.

7. The apparatus of claim 6, wherein the at least one processor is further configured to:
store each of the one or more executed workloads at the buffer or the eviction buffer.

8. The apparatus of claim 6, wherein a portion of a general purpose register (GPR) is partitioned for the eviction buffer, such that each of the one or more executed workloads is transmitted or copied to the partitioned portion of the GPR.

9. The apparatus of claim 1, wherein the at least one processor is further configured to:
execute, upon allocating the at least one other workload to the at least one previously-allocated wave slot, the at least one other workload at the at least one previously-allocated wave slot.

10. The apparatus of claim 1, wherein the at least one other workload is allocated to the at least one previously-allocated wave slot based on the workload order.

11. The apparatus of claim 1, wherein the at least one other workload is subsequent to the one or more workloads in the workload order, such that the at least one other workload is received after the one or more workloads.

12. The apparatus of claim 1, wherein the first workload is an earliest-received workload in the workload order, the second workload is a second earliest-received workload in the workload order, a third workload is a third earliest-received workload in the workload order, and a fourth workload is a fourth earliest-received workload in the workload order.

13. The apparatus of claim 12, wherein the at least one other workload includes at least one of the third workload or the fourth workload, such that at least one of the third workload or the fourth workload is allocated to at least one of the first wave slot or the second wave slot upon finishing executing at least one of the first workload or the second workload.

14. The apparatus of claim 1, wherein each of the plurality of workloads corresponds to at least one of a pixel workload, a pixel warp, or a vertex workload.

15. The apparatus of claim 14, wherein at least one of the pixel workload, the pixel warp, or the vertex workload is associated with at least one of a shader program, a pixel program, or a vertex program.

16. The apparatus of claim 1, wherein each of the plurality of workloads includes at least one of one or more graphics instructions or one or more shader instructions.

17. The apparatus of claim 1, wherein the workload order corresponds to a priority of the plurality of workloads.

18. The apparatus of claim 1, wherein the one or more workloads are allocated to the one or more wave slots by a streaming processor (SP) of a graphics processing unit (GPU).

19. A method of graphics processing, comprising:
receiving a plurality of workloads based on a workload order, each of the plurality of workloads being received in the workload order including at least a first workload and a second workload;
allocating, based on the workload order, one or more workloads of the plurality of workloads to one or more wave slots of a plurality of wave slots, such that at least the first workload is allocated to a first wave slot of the plurality of wave slots and the second workload is allocated to a second wave slot of the plurality of wave slots;
executing the one or more allocated workloads at the one or more wave slots, such that at least the first workload is executed at the first wave slot and the second workload is executed at the second wave slot; and
allocating, upon finishing executing at least one of the one or more allocated workloads, at least one other workload of the plurality of workloads to at least one previously-allocated wave slot of the one or more wave slots, the at least one previously-allocated wave slot having executed at least one of the one or more allocated workloads.

20. The method of claim 19, further comprising:
storing, upon receiving the plurality of workloads, each of the plurality of workloads in a sequence queue, wherein each of the plurality of workloads are stored in the sequence queue based on the workload order.

21. The method of claim 19, further comprising:
determining whether at least one of the one or more allocated workloads is finished executing when at least one of the one or more allocated workloads is still executing,
wherein the at least one other workload is allocated to the at least one previously-allocated wave slot if at least one of the one or more allocated workloads is finished executing when at least one of the one or more allocated workloads is still executing,
wherein the at least one allocated workload that is finished executing is subsequent to the at least one allocated workload that is still executing in the workload order.

22. The method of claim 19, further comprising:
transmitting or copying each of the one or more executed workloads to a buffer or an eviction buffer; and
storing each of the one or more executed workloads at the buffer or the eviction buffer.

23. The method of claim 22, wherein a portion of a general purpose register (GPR) is partitioned for the eviction buffer, such that each of the one or more executed workloads is transmitted or copied to the partitioned portion of the GPR.

24. The method of claim 19, further comprising:
executing, upon allocating the at least one other workload to the at least one previously-allocated wave slot, the at least one other workload at the at least one previously-allocated wave slot.

25. The method of claim 19, wherein the at least one other workload is allocated to the at least one previously-allocated wave slot based on the workload order, wherein the at least one other workload is subsequent to the one or more workloads in the workload order, such that the at least one other workload is received after the one or more workloads.

26. The method of claim 19, wherein the first workload is an earliest-received workload in the workload order, the second workload is a second earliest-received workload in the workload order, a third workload is a third earliest-received workload in the workload order, and a fourth workload is a fourth earliest-received workload in the workload order,
wherein the at least one other workload includes at least one of the third workload or the fourth workload, such that at least one of the third workload or the fourth workload is allocated to at least one of the first wave slot or the second wave slot upon finishing executing at least one of the first workload or the second workload.

27. The method of claim 19, wherein each of the plurality of workloads corresponds to at least one of a pixel workload, a pixel warp, or a vertex workload, wherein at least one of the pixel workload, the pixel warp, or the vertex workload is associated with at least one of a shader program, a pixel program, or a vertex program.

28. The method of claim 19, wherein the one or more workloads are allocated to the one or more wave slots by a streaming processor (SP) of a graphics processing unit (GPU).

29. An apparatus for graphics processing, comprising:
means for receiving a plurality of workloads based on a workload order, each of the plurality of workloads being received in the workload order including at least a first workload and a second workload;
means for allocating, based on the workload order, one or more workloads of the plurality of workloads to one or more wave slots of a plurality of wave slots, such that at least the first workload is allocated to a first wave slot of the plurality of wave slots and the second workload is allocated to a second wave slot of the plurality of wave slots;
means for executing the one or more allocated workloads at the one or more wave slots, such that at least the first workload is executed at the first wave slot and the second workload is executed at the second wave slot; and
means for allocating, upon finishing executing at least one of the one or more allocated workloads, at least one other workload of the plurality of workloads to at least one previously-allocated wave slot of the one or more wave slots, the at least one previously-allocated wave slot having executed at least one of the one or more allocated workloads.

30. A computer-readable medium storing computer executable code for graphics processing, the code when executed by a processor causes the processor to:
receive a plurality of workloads based on a workload order, each of the plurality of workloads being received in the workload order including at least a first workload and a second workload;
allocate, based on the workload order, one or more workloads of the plurality of workloads to one or more wave slots of a plurality of wave slots, such that at least the first workload is allocated to a first wave slot of the plurality of wave slots and the second workload is allocated to a second wave slot of the plurality of wave slots;
execute the one or more allocated workloads at the one or more wave slots, such that at least the first workload is executed at the first wave slot and the second workload is executed at the second wave slot; and
allocate, upon finishing executing at least one of the one or more allocated workloads, at least one other workload of the plurality of workloads to at least one previously-allocated wave slot of the one or more wave slots, the at least one previously-allocated wave slot having executed at least one of the one or more allocated workloads.
